(19) United States
(12) Patent Application Publication
(10) Pub. No.: US 2005/0205623 A1
(43) Pub. Date: Sep. 22, 2005

(54) Hand-held electronic device retainer and positioner

(76) Inventor: Mark K. Buntain, Upper St. Clair, PA (US)

Correspondence Address: Mark K. Buntain, 276 Trotwood Drive, Upper St. Clair, PA, 15241-2247, US

(21) Appl. No.: 10/907,051

(22) Filed: Mar. 18, 2005

Related U.S. Application Data
(60) Provisional application No. 60/553,849, filed on Mar. 18, 2004.

(51) Int. Cl. G06K 9/18

(52) U.S. Cl. 224/217; 224/930

(57) ABSTRACT

The disclosure relates to a flexible material that can be adhered to small devices such as: calculators, cellular phones, Personal Data Assistants, email devices, TV or stereo remotes, digital cameras, laser pointers, electronic toys or the like, and performs as a retainer to the user's hand when one inserts a finger or fingers between the flexible material and the device. The retainer allows the device to be retained on the hand, and also allows the digits of that hand to function and operate the device. The retainer precludes the user from using compressive muscular pressure to hold the device, which can contribute to cramping and pain. The invention also enables the use of these small devices by users with diminished or compromised functionality of the hand or fingers, such as arthritis, amputation or similar.

This application relates to Provisional Application No. 60/553,849.

FIG. 1 through FIG. 5 show a typical embodiment of this invention as it relates to various hand-held devices. The ensuing description refers to the embodiment as depicted in FIG. 1, but can be applied in a similar manner to the devices shown in FIG. 3 through FIG. 5. FIG. 1 shows one embodiment of the invention and how it may relate to existing devices. FIG. 2 shows an embodiment of the invention and how it may relate as a standard feature of a small device. The embodiment depicted is one of a hand-held scientific calculator and the invention being an integral part of the battery cover on the back. An additional embodiment would have a specific area on a surface of a device where this invention would be attached by a variety of means.

FIG. 3 shows the apparatus as it may appear attached on the back of a hand-held calculator. The apparatus shown as item 12 consists of a thin flexible sheet of material that can be repeatedly elongated or stretched, and which reverts to its original size and shape when it is not being distended. The apparatus is attached to the calculator by means of item 18, a thin adhesive film that is adhered to the anterior surface of the apparatus at opposite ends of the attaching planar surface. The areas of adhesive are nominally at the extreme ends of the longer dimension so that the flexible material between the areas adhered to the device is allowed to flex and distend. FIG. 3 shows slots 14 and 16 which allow the user to quickly locate the opening between adjacent areas of the apparatus, and to slip one or more digits of the hand between the apparatus and the hand-held device. When a digit (or digits) is inserted between the apparatus and the hand-held device, the flexible sheet item 12 is distended, but remains in constant contact with the digit. The amount of pressure that is applied to the digit is dependent upon the cross-sectional volume of the flexible material 12, and its chemical composition. The chemical composition of the flexible material determines its coefficient of elasticity or its percentage of elongation. The slots 14 and 16 allow the user to select one, two or three of the flexible material segments depending upon the amount of tension desired for the application.

The openings shown as items 14 and 16 allow the user to quickly locate the opening in the apparatus and are accessible from either side, thereby allowing item 13 to be either left-handed or right-handed, or some other object used for support of the hand-held device.

The openings shown as items 14 and 16 divide the apparatus into multiple segments of flexible material, allowing for variation in position on item 13. The fact that there may be multiple segments of flexible material allows for variability in the amount of tension that is applied to item 13. If item 11 is imbalanced while being retained, then more than one segment of the apparatus may be engaged by the digits of item 13 to provide more holding or retaining tension.

From the foregoing description, a number of advantages of this invention become evident:
(1) it is a simple apparatus that can be retrofitted to existing devices that lack a means of being retained or positioned in one's hand or on one's finger(s).
(2) the apparatus is universal in nature, and may be applied to a variety of devices.
(3) it enables users with limited functionality of their hands or fingers the opportunity to more easily retain small hand-held electronic devices.
(4) this design can be incorporated as an integral feature into new designs of small hand-held electronic devices and offered as a standard feature.

### OPERATION OF INVENTION

The use of this invention is accomplished in the following manner, as described by using a hand-held calculator as an example.

The calculator would be held in such a manner in the hand opposite the one in which you want to retain the calculator so that the invention would be visible and accessible. One or more fingers would be placed at one of the cut-outs (item 14 or 16) and slipped between the invention and the calculator. Once inserted, the calculator can then be positioned so that the thumb of the holding-hand can be used to actuate the keys. The calculator does not need to be laid down between successive uses, but can simply remain attached to the hand. It is even possible to operate the calculator using only the thumb of the holding hand. Removal of one's hand from the calculator is simply accomplished by retracting the finger(s) while applying a slight rotation of the calculator away from the hand.

Although the foregoing description contains many details and specific statements, these should not be construed as limiting the scope of the invention, but as merely providing illustrations of some of the presently preferred embodiments of this invention. For example, perimeter shape, and the number and shape of the cut-outs (item 14 & 16) can be of infinite variety. Likewise, the attachment means may vary dependent upon the application of the invention to a specific device.

Therefore the scope of this invention should be determined by the appended claims and their legal equivalents, rather than by any examples contained herein.

### DISCUSSION OF PRIOR ART

Heretofore, hand-held devices employed various means of retention and positioning. U.S. Pat. No. 6,164,853 issued to Foote, Dec. 26, 2000, teaches in its claim an example of an ergonomic housing that has an attached strap for retention. This claim relates to the “ergonomic housing” and does not relate to pre-existing, in-use devices such as this present invention relates to.

U.S. Pat. No. 6,360,928 issued to Russo, Mar. 26, 2002, teaches a device wherein a strap can be attached strapped to one's hand, with an electronic device then attached to the attached strap. This apparatus precludes the operator from operating the attached device with the hand that it is attached to. The apparatus, while secure and robust, requires considerable time and effort to attach and subsequently detach.

U.S. Pat. No. 5,309,328 issued to Lum, May 3, 1994, teaches a device that is securely attached to one's forearm, allowing the hand to perform other functions. This invention does not relate to pre-existing or in-use devices such as this present invention.

U.S. Pat. No. 5,875,945 issued to Roach, Mar. 2, 1999, teaches a device for hand-held attack repellant that embodies an attachment means that encircles the individual digits on one's hand. The disadvantage of this type invention is that it provides no ability to position a device in a functional position, and to retain that desired position as does the present invention.

U.S. Pat. No. 6,796,467 issued to Caldana, Sep. 28, 2004, teaches a device that is secured to one's arm that attaches a cellular phone or other small device. The disadvantage of this invention is that it and the attached device remain attached to the arm, with potential interference with clothing such as winter coats. The present invention precludes such interference by being useable on a temporary basis, and by being able to be used even with gloves on one's hand.

### OBJECTS AND ADVANTAGES

Accordingly, objects and advantages of this present invention are:
(1) to provide an apparatus that is universal in application, and is applicable for pre-existing and in-use devices, as well as future devices that may be acquired by the user.
(2) to provide an apparatus that allows a user of a small device the ability to retain the device to their person without the requirement of applying muscular pressure or tension in a grasping or clamping action.
(3) to provide an apparatus that can quickly and simply be applied without buckles, buttons, straps, snaps, or other cumbersome means that require manual dexterity to operate.
(4) to provide an apparatus that is functional without regard to ‘handedness’ of the user.
(5) to provide an apparatus by which small devices may be used by persons having diminished hand or finger functionality.
(6) to provide an apparatus by which small devices may be used by persons lacking normal hand or appendage functionality.
(7) to provide an apparatus that provides for retention and positioning of a device while simultaneously allowing the use of digits of both hands for operation of the device.
(8) to provide an apparatus that is useable simultaneously with other attached personal safety equipment or clothing such as gloves.

Further objects and advantages of this invention will become apparent from consideration of the drawings and ensuing description of it.

### DESCRIPTION OF DRAWINGS

FIG. 1 is a perspective view of my invention depicting the relative location of adhesive application areas.

FIG. 2 is a perspective view of my invention as it relates to a hand-held calculator or other device component cover.

FIG. 3 is a perspective view of my invention as it relates to a hand-held calculator.

FIG. 4 is a perspective view of my invention as it relates to a hand-held calculator device, with one's finger or fingers inserted into the apparatus.

FIG. 5 is a perspective view of my invention as it relates to an email device, PDA, or cellular phone, with one's finger or fingers inserted into the apparatus.

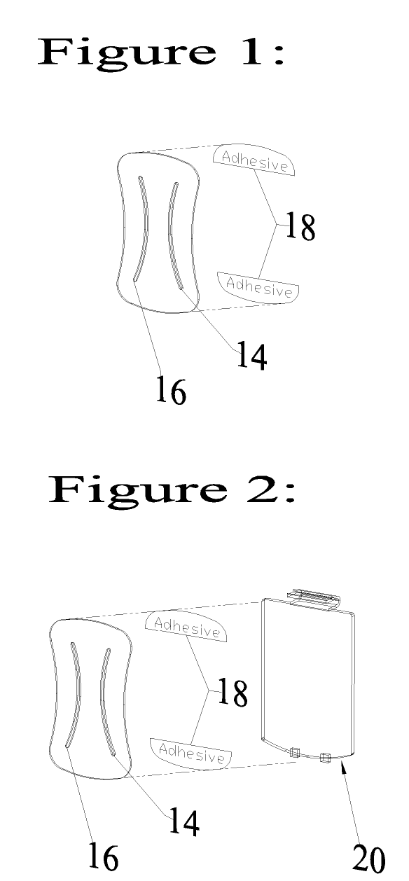

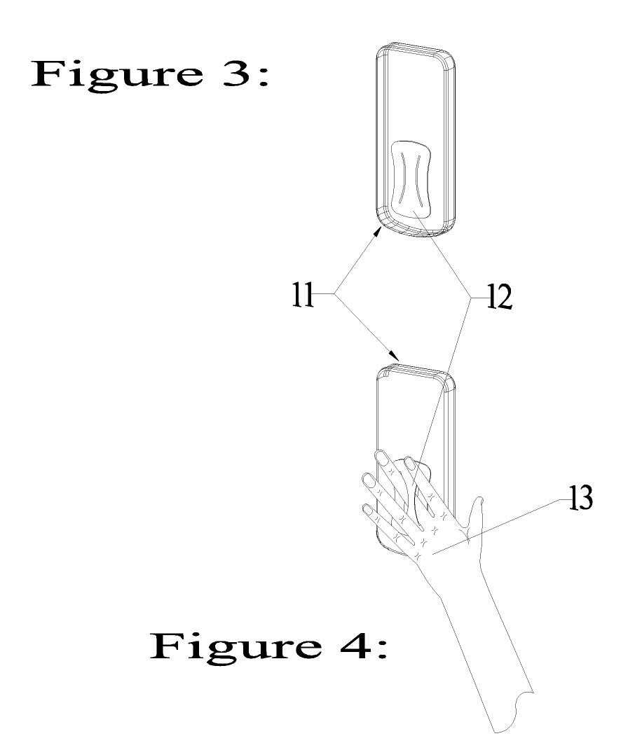

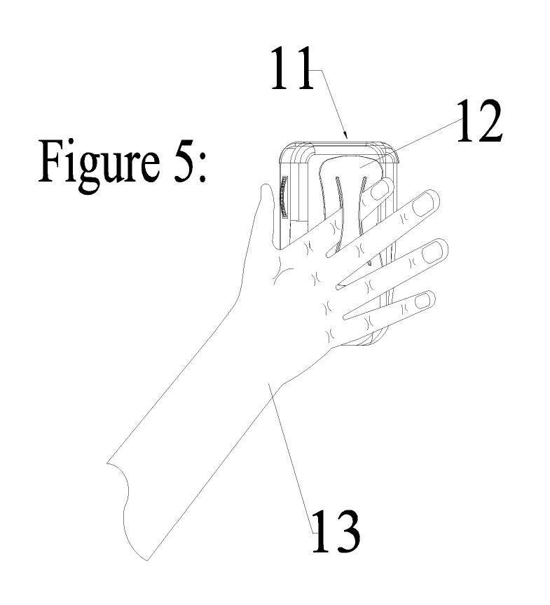

### LIST OF FIGURE REFERENCE NUMBERS

Item # 11: Hand-held device, such as: calculator, cellular phone, camera, PDA, email device, electronic remote transmitter, or similar device.

Item # 12: This invention.

Item # 13: Object that item 11 is held to with this invention, such as a hand, finger, or prosthetic device.

Item # 14: Gap or opening in flexible material.

Item # 16: Gap or opening in flexible material.

Item # 18: Adhesive area between device #11 and invention #12.

Item # 20: Device component cover.

1. A retainer apparatus for securing a device on a user's hand or fingers, including:
a flexible piece of material of sufficient size and shape to provide tension on a supporting member inserted between said device and said flexible material;
a means for attaching said piece of material to said device;
a means for attaining an acceptable amount of tension for retaining said device on said supporting member.

2. The retainer apparatus for securing a device on a user's hand or fingers of claim 1 wherein said means for attaching said piece of material to said device includes two distal areas of adhesive adhered to a common planar face of said flexible material.

3. The retainer apparatus for securing a device on a user's hand or fingers of claim 1 wherein said means for attaining an acceptable amount of tension for retaining said device includes a plurality of sections of said flexible material separated by a cut-out relief.

4. A retainer apparatus for securing a device on a user's hand or fingers including:
a flexible piece of material of sufficient size and shape to provide tension on a supporting member inserted between said device and said flexible material;
an attaching means for securing said piece of flexible material to said device;
a means for attaining an acceptable amount of tension for retaining said device on said supporting member.

5. The retainer apparatus for securing a device on a user's hand or fingers of claim 4 including:
an integral surface of appropriate size, shape and material to cover internal components of said device such as batteries;
a means of integrally attaching said retainer apparatus to said component cover;
a means for attaining an acceptable amount of tension for retaining said device on said supporting member.
